(19) United States
(12) Patent Application Publication
(10) Pub. No.: US 2026/0133900 A1
(43) Pub. Date: May 14, 2026

(54) STORAGE DEVICE AND A METHOD FOR OPERATING STORAGE DEVICE

(71) Applicant: Samsung Electronics Co., Ltd., Suwon-si (KR)

(72) Inventor: Nam Wook KANG, Suwon-si (KR)

(73) Assignee: Samsung Electronics Co., Ltd., Suwon-si (KR)

(21) Appl. No.: 19/196,559

(22) Filed: May 1, 2025

(30) Foreign Application Priority Data
Nov. 12, 2024 (KR) 10-2024-0160244

(51) Int. Cl. G06F 12/02

(52) U.S. Cl. CPC G06F 12/0223

(57) ABSTRACT

A storage device according to some example embodiments may include a non-volatile memory device including a plurality of memory cells configured to store user data and metadata, and a storage controller including a plurality of cores, the storage controller configured to issue the metadata to one of the plurality of memory cells based on whether each of a plurality of paths corresponding to each of the plurality of cores is in a busy state.

### CROSS-REFERENCE TO RELATED APPLICATION

This application claims priority to and the benefit of Korean Patent Application No. 10-2024-0160244 filed at the Korean Intellectual Property Office on Nov. 12, 2024, the entire contents of which are incorporated herein by reference in their entirety.

### BACKGROUND

Some example embodiments of the present inventive concepts relate to storage devices and methods for operating the storage devices.

Non-volatile memory devices are memory devices that retain stored data even when power is cut off. Non-volatile memory devices include Read Only Memory ROM, Programmable ROM PROM, Electrically Programmable ROM EPROM, Electrically Erasable and Programmable ROM EEPROM, flash memory devices, Phase-change RAM PRAM, Magnetic RAM MRAM, Resistive RAM RRAM, and Ferroelectric RAM FRAM.

Among them, flash memory devices store a set of address mapping information in memory blocks for operations such as read and write on data. While storing data, metadata representing address mapping information of the data may be stored in flash memory.

Meanwhile, the number of NAND dies included in high-capacity SSD Solid State Drives has been increasing recently, which has led to problems such as increased buffering and longer channel occupancy times when storing metadata. However, currently, metadata is stored sequentially without scheduling, which may degrade and/or reduce an SSD's performance.

### SUMMARY

Some example embodiments of the present inventive concepts provide a storage device and a method for operating the storage device with improved performance by setting the storage order of metadata.

According to some example embodiments of the present inventive concepts, a storage device may include a non-volatile memory device including a plurality of memory cells configured to store user data and metadata, and a storage controller including a plurality of cores, the storage controller configured to issue metadata to one of the plurality of memory cells based on whether each of a plurality of paths corresponding to each of the plurality of cores is in a busy state.

A storage device according to some example embodiments may include a non-volatile memory device including a plurality of memory cells configured to store user data and metadata, and a storage controller configured to issue the metadata to a plurality of first memory cells among the plurality of memory cells based on whether each of the plurality of memory cells is in a busy state.

A method of operating a storage device according to some example embodiments may include constructing metadata based on user data, determining a location where the metadata is to be stored based on whether each of a plurality of paths corresponding to each of a plurality of cores included in a storage controller is in a busy state, whether each of a plurality of channels connected to each of the plurality of cores is in the busy state, and whether each of a plurality of memory cells of a non-volatile memory device is in the busy state, issuing the metadata to the location, and updating the location of the metadata.

According to some example embodiments, a storage system may include a host, and a storage device. The storage device may include a non-volatile memory device including a plurality of memory cells configured to store user data and metadata received from the host, and a storage controller including a plurality of cores. The storage controller may be configured to issue the metadata to one of the plurality of memory cells based on whether each of a plurality of paths corresponding to each of the plurality of cores is in a busy state.

### BRIEF DESCRIPTION OF THE DRAWINGS

FIG. 1 is a block diagram illustrating a storage system according some example embodiments.

FIG. 2 is a block diagram exemplarily illustrating a software layer of a storage system according to some example embodiments.

FIG. 3 is a block diagram illustrating a storage device according to some example embodiments.

FIG. 4 is a block diagram illustrating a storage device according to some example embodiments.

FIG. 5 is a block diagram illustrating a storage controller according to some example embodiments.

FIG. 6 is a block diagram illustrating a non-volatile memory device according to some example embodiments.

FIG. 7 is a circuit diagram exemplarily showing one memory block among a plurality of memory blocks included in a memory cell array according to some example embodiments.

FIG. 8 is a diagram for explaining the operation of a storage device according to some example embodiments.

FIG. 9 is a diagram for explaining the operation of a storage device according to some example embodiments.

FIG. 10 is a diagram for explaining the operation of a storage device according to some example embodiments.

FIG. 11 is a diagram for explaining the operation of a storage device according to some example embodiments.

FIG. 12 is a diagram for explaining the operation of a storage device according to some example embodiments.

FIG. 13 is a diagram for explaining the operation of a storage device according to some example embodiments.

FIG. 14 is a diagram for explaining the operation of a storage device according to some example embodiments.

FIG. 15 is a diagram for explaining the operation of a storage device according to some example embodiments.

FIG. 16 is a flowchart illustrating the operation of a storage device according to some example embodiments.

FIG. 17 is a block diagram exemplarily showing a mobile system to which a storage device according to some example embodiments is applied.

FIG. 18 is a block diagram exemplarily showing a computing device to which a storage device according to some example embodiments is applied.

FIG. 19 is a block diagram exemplarily showing a system to which a storage device according to some example embodiments is applied.

FIG. 20 is a block diagram exemplarily showing a system to which a storage device according to some example embodiments is applied.

### DETAILED DESCRIPTION

In the following detailed description, only some example embodiments of the present inventive concepts have been shown and described, simply by way of illustration. As those skilled in the art would realize, the described example embodiments may be modified in various different ways, all without departing from the spirit or scope of the present inventive concepts.

Accordingly, the drawings and description are to be regarded as illustrative in nature and not restrictive. Like reference numerals designate like elements throughout the disclosure. In the flow charts described with reference to the drawings, the order of operations may be changed, and several operations may be combined, and an operation may be divided, and some operations may not be performed.

Further, expressions written in the singular forms can be comprehended as the singular forms or plural forms unless clear expressions such as “a”, “an”, or “single” are used. Terms including an ordinal number, such as first and second, are used for describing various constituent elements, but the constituent elements are not limited by the terms. These terms are used only to discriminate one constituent element from other constituent elements.

Hereinafter, some example embodiments of the present inventive concepts will be described in more detail through examples. These example embodiments are just for illustrating the present inventive concepts, and the right protection scope of the present inventive concepts are not limited by the example embodiments.

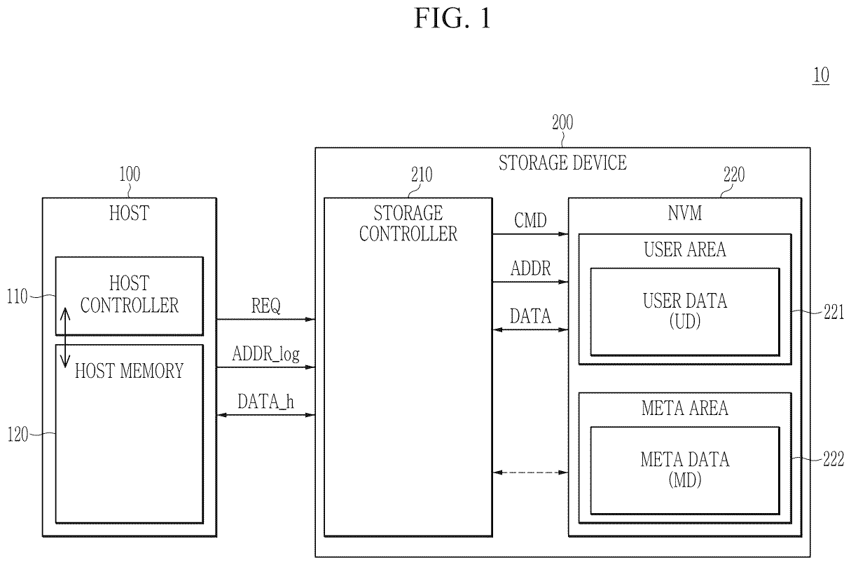

FIG. 1 is a block diagram illustrating a storage system according to some example embodiments.

Referring to FIG. 1, a storage system 10 may include a host 100 and a storage device 200. The host 100 may include a host controller 110 and host memory 120. The host memory 120 can function as a buffer memory for temporarily storing data DATA_h to be transmitted or sent to the storage device 200 or data DATA_h transmitted or sent from the storage device 200.

The storage device 200 may include a storage controller 210 and a non-volatile memory device 220. Each of the storage controller 210 and the non-volatile memory device 220 may be provided as different chips, different packages, and/or different modules, in which case the storage controller 210 and the non-volatile memory device 220 may be electrically connected.

Alternatively, in some example embodiments, the storage controller 210 and the non-volatile memory device 220 may be mounted on packages such as Package on Package (PoP), Ball Grid Arrays (BGAs), Chip Scale Packages (CSPs), Plastic Leaded Chip Carrier (PLCC), Plastic Dual In-Line Package (PDIP), Die in Waffle Pack, Die in Wafer Form, Chip On Board (COB), Ceramic Dual In-Line Package (CERDIP), Plastic Metric Quad Flat Pack (MQFP), Thin Quad Flatpack (TQFP), Small Outline SOIC, Shrink Small Outline Package (SSOP), Thin Small Outline (TSOP), Thin Quad Flatpack (TQFP), System In Package (SIP), Multi Chip Package (MCP), Wafer-level Fabricated Package (WFP), Wafer-Level Processed Stack Package (WSP), and the like, and may be provided as a non-volatile memory system.

The storage controller 210 can receive a request REQ, an address ADDR_log, and data DATA_h from the host 100, and control a non-volatile memory device 220 in response to the received signals. For example, the storage controller 210 may transmit or send a command CMD and an address ADDR to the non-volatile memory device 220 to write data DATA to the non-volatile memory device 220 or to read data DATA stored in the non-volatile memory device 220.

A request REQ from the host 100 may include a read or write request for data. According to some example embodiments, the request REQ may include a sequential Write request, a discard request, etc., but example embodiments are not necessarily limited thereto.

The address ADDR_log received from the host 100 may be, for example, a logical address, and the address ADDR transmitted or sent to the non-volatile memory device 220 may be a physical address of the non-volatile memory device 220. A logical address may refer to location information of a data unit defined or managed by the host 100. A physical address may refer to location information of a data unit defined according to the operating characteristics of the non-volatile memory device 220.

The non-volatile memory device 220 can write data DATA received from the storage controller 210 and/or transmit or send stored data DATA to the storage controller 210 under the control of the storage controller 210. In some example embodiments, the non-volatile memory device 220 may include NAND flash memories, but example embodiments are not necessarily limited thereto, and the non-volatile memory device 220 may also include non-volatile memory elements such as NAND flash, PRAM, ReRAM, MRAM, FRAM, etc., having a three-dimensional structure.

The non-volatile memory device 220 may include a user area 221 and a meta area 222. The user area 221 may correspond to an area storing user data UD, and the meta area 222 may correspond to an area storing metadata MD.

User data UD may include data used or generated in a software layer such as the host 100, such as program code, files, etc. Metadata MD may include structured information of the user data UD stored in the user area 221. In some example embodiments, the metadata MD may include an address mapping table including a plurality of sub-address mapping tables, which are mapping information between the logical addresses and physical addresses described above according to some example embodiments. In some example embodiments, data DATA transferred between the storage controller 210 and the non-volatile memory device 220 may include the user data UD and the metadata MD.

In some example embodiments, the non-volatile memory device 220 can program user data UD in the user area 221 based on a multi-level cell, triple-level cell, and/or quad-level cell program method. In some example embodiments, the non-volatile memory device 220 may program metadata MD into the meta area 222 based on a single level cell program method to increase the reliability of data stored in the meta area 222, but example embodiments are not limited thereto.

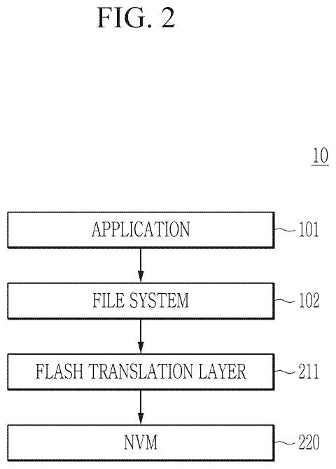

FIG. 2 is a block diagram exemplarily illustrating a software layer of a storage system according to some example embodiments.

Referring to FIGS. 1 and 2, the software layer of the storage system 10 may include an application 101, a file system 102, and a flash translation layer 211.

Application 101 may refer to various application programs running on the host 100. For example, the application 101 may include an operating system, a document editor, a web browser, a video player, and/or a game program, etc., but example embodiments are not limited thereto.

The file system 102 may play a role in organizing files and/or data used by the application 101 when storing them in the non-volatile memory device 220.

For example, the file system 102 can provide a logical address ADDR_log of a file or data to a storage device 200, and the file system 102 can have various forms depending on the operating system of the host 100. The file system 102 can define data in units of sectors or logical block addresses.

In some example embodiments, the application 101 and/or the file system 102 may be driven by the host 100, and the application 101 and/or the file system 102 may be loaded into the host memory 120.

A flash translation layer (FTL) 211 can provide an interface between the host 100 and the non-volatile memory device 220 so that the non-volatile memory device 220 can be used efficiently.

According to some example embodiments, since the non-volatile memory device 220 can write and read data in units of pages, while the file system 102 manages data and/or files in units of sectors or logical block addresses as described above in some example embodiments, the FTL 211 can receive a logical address ADDR_log and convert it into a physical address ADDR that can be used in the non-volatile memory device 220. FTL 211 can manage these address mapping operations through the address mapping table included in the metadata MD described above.

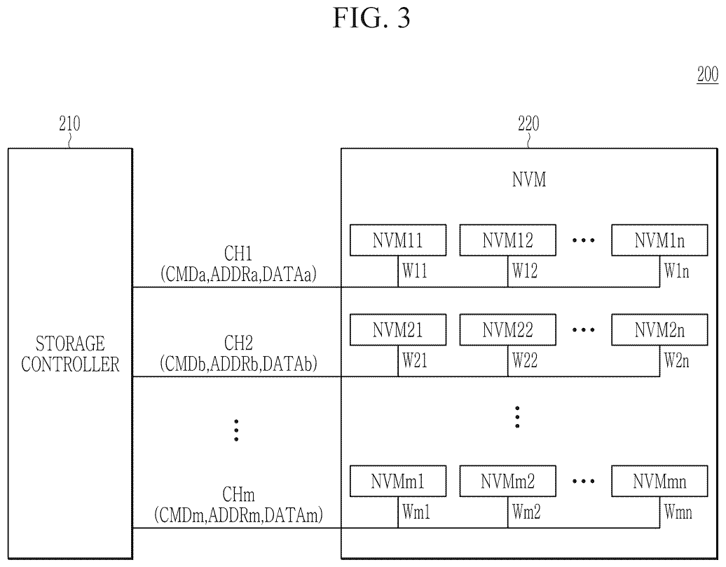

FIG. 3 is a block diagram illustrating a storage device according to some example embodiments.

Referring to FIG. 3, the storage device 200 may include a non-volatile memory device 220 and a storage controller 210.

The storage device 200 can support a plurality of channels CH1 to CHm, and the non-volatile memory device 220 and the storage controller 210 can be connected through the plurality of channels CH1 to CHm. For example, the storage device 200 may be implemented as a storage device such as a Solid State Drive (SSD).

The non-volatile memory device 220 may include a plurality of non-volatile memory devices NVM11 to NVMmn. Each of the non-volatile memory devices NVM11 to NVMmn can be connected to one of a plurality of channels CH1 to CHm through a corresponding way. For example, non-volatile memory devices NVM11 to NVM1n can be connected to a first channel CH1 through ways W11 to W1n, and non-volatile memory devices NVM21 to NVM2n can be connected to a second channel CH2 through ways W21 to W2n.

In some example embodiments, each of the non-volatile memory devices NVM11 to NVMmn may be implemented as an arbitrary memory unit that can operate according to individual commands from the storage controller 210. For example, each of the non-volatile memory devices NVM11 to NVMmn may be implemented as a chip or a die, but example embodiments are not limited thereto.

The storage controller 210 can transmit or send and receive signals with the non-volatile memory device 220 through the plurality of channels CH1 to CHm. For example, the storage controller 210 can transmit or send commands CMDa to CMDm, addresses ADDRa to ADDRm, and data DATAa to DATAm to the non-volatile memory device 220 through the plurality of channels CH1 to CHm, and/or receive data DATAa to DATAm from the non-volatile memory device 220.

The storage controller 210 can select one of the non-volatile memory devices NVM11 to NVMmn connected to each channel through each channel, and transmit or send and receive signals with the selected non-volatile memory device.

For example, the storage controller 210 can select a non-volatile memory device NVM11 among the non-volatile memory devices NVM11 to NVM1n connected to the first channel CH1. The storage controller 210 can transmit or send a command CMDa, an address ADDRa, and data DATAa to the selected non-volatile memory device NVM11 through the first channel CH1, and/or receive data DATAa from the selected non-volatile memory device NVM11.

The storage controller 210 can transmit or send and receive signals in parallel with the non-volatile memory device 220 through different channels. For example, the storage controller 210 may transmit or send a command CMDb to the non-volatile memory device 220 through the second channel CH2 while transmitting or sending a command CMDa to the non-volatile memory device 220 through the first channel CH1. For example, the storage controller 210 may receive data DATAb from the non-volatile memory device 220 through the second channel CH2 while receiving data DATAa from the non-volatile memory device 220 through the first channel CH1.

The storage controller 210 can control the overall operation of the non-volatile memory device 220. The storage controller 210 can control each of the non-volatile memory devices NVM11 to NVMmn connected to the channels CH1 to CHm by transmitting or sending signals to the channels CH1 to CHm. For example, the storage controller 210 can control a selected one of the non-volatile memory devices NVM11 to NVM1n by transmitting or sending a command CMDa and an address ADDRa to the first channel CH1.

Each of the non-volatile memory devices NVM11 to NVMmn can operate under the control of the storage controller 210. For example, a non-volatile memory device NVM11 can program data DATAa according to a command CMDa and an address ADDRa provided to the first channel CH1. For example, a non-volatile memory device NVM21 can read data DATAb according to a command CMDb and an address ADDRb provided to a second channel CH2 and transmit or send the read data DATAb to a storage controller 210.

Meanwhile, in FIG. 3, the non-volatile memory device 220 is illustrated as communicating with the storage controller 210 through m channels, and the non-volatile memory device 220 includes n non-volatile memory devices corresponding to each channel, but example embodiments are not necessarily limited thereto, and in some example embodiments, the number of channels and the number of non-volatile memory devices connected to one channel may be variously changed.

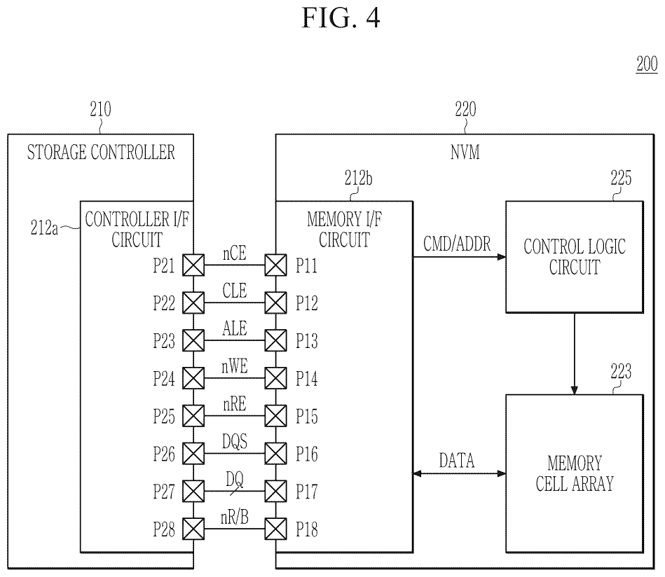

FIG. 4 is a block diagram illustrating a storage device according to some example embodiments.

Referring to FIG. 4, the storage device 200 may include a storage controller 210 and a non-volatile memory device 220. The non-volatile memory device 220 may correspond to one of the non-volatile memory devices NVM11 to NVMmn that communicate with the storage controller 210 based on one of the plurality of channels CH1 to CHm of FIG. 3.

The non-volatile memory device 220 may include first to eighth pins P11 to P18, a memory interface circuit 212b, a memory cell array 223, and a control logic circuit 225.

The memory interface circuit 212b can receive a chip enable signal nCE from the storage controller 210 through the first pin P11. The memory interface circuit 212b can transmit or send and receive signals with the storage controller 210 through the second to eighth pins P12 to P18 according to the chip enable signal nCE. For example, when the chip enable signal nCE is in an enabled state e.g., low level, the memory interface circuit 212b can transmit or send and receive signals with the storage controller 210 through the second to eighth pins P12 to P18.

The memory interface circuit 212b can receive a command latch enable signal CLE, an address latch enable signal ALE, and a write enable signal nWE from the storage controller 210 through the second to fourth pins P12 to P14, respectively. The memory interface circuit 212b can receive a data signal DQ from the storage controller 210 and/or transmit or send a data signal DQ to the storage controller 210 through the seventh pin P17. Commands CMD, addresses ADDR, and data DATA can be transmitted or sent via data signals DQ.

For example, a data signal DQ can be transmitted or sent over a plurality of data signal lines. In some example embodiments, the seventh pin P17 may include a plurality of pins corresponding to the plurality of data signals DQ.

The memory interface circuit 212b can obtain a command CMD from a data signal DQ received in an enable period e.g., a high level state of a command latch enable signal CLE based on the toggle timings of a write enable signal nWE. The memory interface circuit 212b can obtain an address ADDR from a data signal DQ received in an enable period e.g., high level state of an address latch enable signal ALE based on the toggle timings of a write enable signal nWE.

In some example embodiments, the write enable signal nWE can remain in a static state e.g., at a high level or a low level and toggle between the high level and the low level. For example, the write enable signal nWE can be toggled during a period where a command CMD or an address ADDR is transmitted or sent. Accordingly, the memory interface circuit 212b can obtain a command CMD or an address ADDR based on the toggle timings of the write enable signal nWE.

The memory interface circuit 212b can receive a read enable signal nRE from the storage controller 210 through the fifth pin P15. The memory interface circuit 212b can receive a data strobe signal DQS from the storage controller 210 through the sixth pin P16, and/or transmit or send a data strobe signal DQS to the storage controller 210.

In a data DATA output operation of a non-volatile memory device 220, the memory interface circuit 212b can receive a read enable signal nRE that toggles through the fifth pin P15 before outputting data DATA. The memory interface circuit 212b can generate a data strobe signal DQS that toggles based on the toggling of the read enable signal nRE. For example, the memory interface circuit 212b may generate a data strobe signal DQS that begins to toggle after a predetermined, or alternatively desired delay e.g., tDQSRE based on the toggling start time of the read enable signal nRE. The memory interface circuit 212b can transmit or send a data signal DQ including data DATA based on the toggle timing of a data strobe signal DQS. Accordingly, data DATA can be transmitted or sent to the storage controller 210 aligned with the toggle timing of the data strobe signal DQS.

In a data DATA input operation of a non-volatile memory device 220, when a data signal DQ including data DATA is received from a storage controller 210, the memory interface circuit 212b can receive a data strobe signal DQS that toggles together with the data DATA from the storage controller 210. The memory interface circuit 212b can obtain data DATA from the data signal DQ based on the toggle timing of the data strobe signal DQS. For example, the memory interface circuit 212b can obtain data DATA by sampling the data signal DQ at the rising edge and falling edge of the data strobe signal DQS.

The memory interface circuit 212b can transmit or send a ready/busy output signal nR/B to the storage controller 210 through the 8th pin P18. The memory interface circuit 212b can transmit or send status information of the non-volatile memory device 220 to the storage controller 210 through a ready/busy output signal nR/B. When the non-volatile memory device 220 is in a busy state e.g., when internal operations of the non-volatile memory device 220 are being performed, the memory interface circuit 212b can transmit or send the ready/busy output signal nR/B indicating the busy state to the storage controller 210. When the non-volatile memory device 220 is in a ready state e.g., internal operations of the non-volatile memory device 220 are not performed or completed, the memory interface circuit 212b can transmit or send a ready/busy output signal nR/B indicating the ready state to the storage controller 210. For example, while a non-volatile memory device 220 reads data DATA from a memory cell array 223 in response to a page read command, the memory interface circuit 212b may transmit or send a ready/busy output signal nR/B indicating a busy state e.g., low level to the storage controller 210. For example, while a non-volatile memory device 300 programs data DATA into a memory cell array 223 in response to a program command, the memory interface circuit 212b may transmit or send a ready/busy output signal nR/B indicating a busy state to the storage controller 210.

The control logic circuit 225 can control the overall operation of the non-volatile memory device 220. The control logic circuit 225 can receive a command/address CMD/ADDR obtained from the memory interface circuit 212b. The control logic circuit 225 can generate control signals for controlling other components of the non-volatile memory device 220 according to the received command/address CMD/ADDR. For example, the control logic circuit 225 can generate various control signals for programming data DATA into the memory cell array 223 and/or reading data DATA from the memory cell array 223.

The memory cell array 223 can store data DATA obtained from the memory interface circuit 212b under the control of the control logic circuit 225. The memory cell array 223 can output stored data DATA to the memory interface circuit 212b under the control of the control logic circuit 225.

The memory cell array 223 may include a plurality of memory cells. For example, the plurality of memory cells may be flash memory cells. However, example embodiments of the present inventive concepts are not limited thereto, and the memory cells may be RRAM cells, FRAM cells, PRAM cells, TRAM Thyristor Random Access Memory cells, and MRAM cells. Below, the memory cells will be described as NAND flash memory cells.

The storage controller 210 may include first to eighth pins P21 to P28 and a controller interface circuit 212a. The first to eighth pins P21 to P28 may correspond to the first to eighth pins P11 to P18 of the non-volatile memory device 220.

The controller interface circuit 212a can transmit or send a chip enable signal nCE to the non-volatile memory device 220 through the first pin P21. The controller interface circuit 212a can transmit or send and/or receive signals to and from a selected non-volatile memory device 220 through the chip enable signal nCE and the second to eighth pins P22 to P28.

The controller interface circuit 212a can transmit or send a command latch enable signal CLE, an address latch enable signal ALE, and a write enable signal nWE to the non-volatile memory device 220 through the second to fourth pins P22 to P24. The controller interface circuit 212a can transmit or send a data signal DQ to the non-volatile memory device 220 and/or receive a data signal DQ from the non-volatile memory device 220 via the seventh pin P27.

The controller interface circuit 212a can transmit or send a data signal DQ including a command CMD and/or an address ADDR together with a toggling write enable signal nWE to the non-volatile memory device 220. The controller interface circuit 212a can transmit or send a data signal DQ including a command CMD to the non-volatile memory device 220 by transmitting or sending a command latch enable signal CLE having an enable state, and can transmit or send a data signal DQ including an address ADDR to the non-volatile memory device 220 by transmitting or sending an address latch enable signal ALE having an enable state.

The controller interface circuit 212a can transmit or send a read enable signal nRE to the non-volatile memory device 220 through the fifth pin P25. The controller interface circuit 212a can receive a data strobe signal DQS from a non-volatile memory device 220 through the sixth pin P26, and/or transmit or send a data strobe signal DQS to the non-volatile memory device 220.

In a data output operation of a non-volatile memory device 220, the controller interface circuit 212a can generate a toggling read enable signal nRE and transmit or send the read enable signal nRE to the non-volatile memory device 220. For example, the controller interface circuit 212a may generate a read enable signal nRE that changes from a fixed state e.g., a high level or a low level to a toggle state before data DATA is output. Accordingly, a data strobe signal DQS that toggles based on a read enable signal nRE in the non-volatile memory device 220 can be generated. The controller interface circuit 212a can receive a data signal DQ containing data DATA together with a toggling data strobe signal DQS from a non-volatile memory device 220. The controller interface circuit 212a can obtain data DATA from the data signal DQ based on the toggle timing of the data strobe signal DQS.

In a data input operation of a non-volatile memory device 220, the controller interface circuit 212a can generate a toggling data strobe signal DQS. For example, the controller interface circuit 212a may generate a data strobe signal DQS that changes from a fixed state e.g., a high level or a low level to a toggle state before transmitting or sending data DATA. The controller interface circuit 212a can transmit or send a data signal DQ containing data DATA to a non-volatile memory device 220 based on the toggle timings of the data strobe signal DQS.

The controller interface circuit 212a can receive a ready/busy output signal nR/B from the non-volatile memory device 220 through the eighth pin P28. The controller interface circuit 212a can determine status information of the non-volatile memory device 220 based on the ready/busy output signal nR/B.

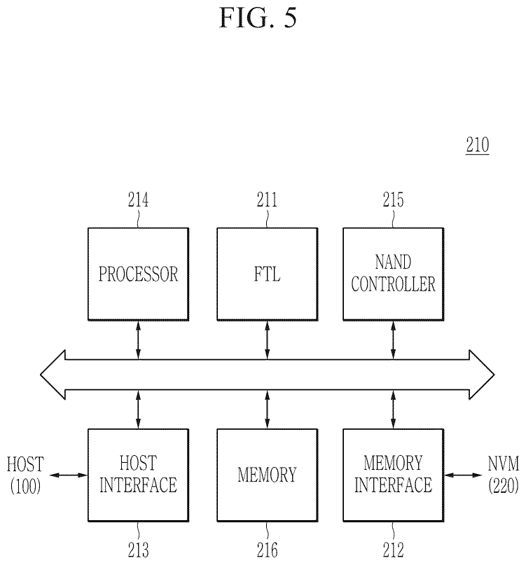

FIG. 5 is a block diagram illustrating a storage controller according to some example embodiments.

Referring to FIG. 5, the storage controller 210 may include an FTL 211, a memory interface 212, a host interface 213, a processor 214, a NAND controller 215, and a memory 216.

FTL 211 may be provided in hardware and/or software form and may be driven by the processor 214. If FTL 211 is provided in software form, it can be loaded into memory 213 and operated by the processor 214. In some example embodiments, the FTL 211 may be provided in hardware form such as a dedicated circuit.

In addition to the functions described in detail with reference to FIG. 2, in some example embodiments, the FTL 211 may perform operations such as garbage collection, wear leveling, etc., but example embodiments are not limited thereto. For example, FTL 211 can manage the number of program/erase cycles of a plurality of memory blocks included in a non-volatile memory device 220 and perform wear leveling based on this so that the number of program/erase cycles of the plurality of memory blocks is equalized.

The storage controller 210 can communicate with a non-volatile memory device 220 via a memory interface 212 as described with reference to FIGS. 3 and 4. The storage controller 210 can also communicate with the host 100 via the host interface 213.

In some example embodiments, the host interface 213 may include various interfaces such as Universal Serial Bus USB, multimedia card MMC, peripheral component interconnection PCI, PCI-express, Advanced Technology Attachment (ATA), Serial-ATA, Parallel-ATA, small computer small interface (SCSI), enhanced small disk interface (ESDI), Integrated Drive Electronics (IDE), Mobile Industry Processor Interface (MIPI), NVMe, etc., but example embodiments are not limited thereto.

The processor 214 can control all operations of the storage controller 210. The processor 214 may be implemented as a CPU, an AP, a GPU, etc., but example embodiments are not necessarily limited thereto.

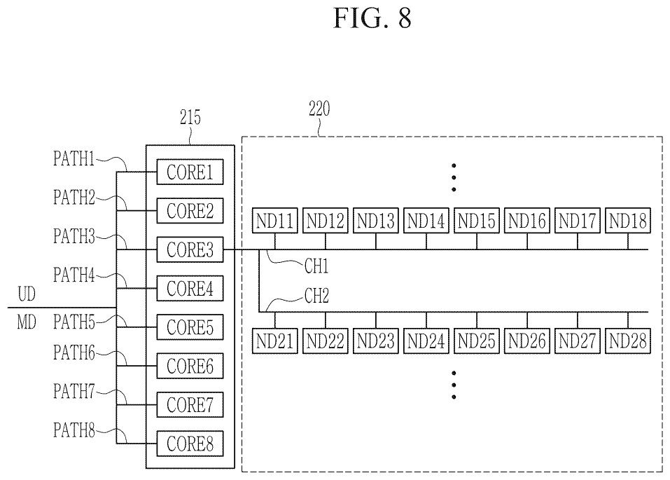

A NAND controller 215 can issue metadata to any one of a plurality of NAND dies of a non-volatile memory device 220. The NAND controller 215 can monitor whether a plurality of cores included in the NAND controller 215 and a plurality of paths corresponding thereto are in a busy state, whether a plurality of channels connected to a non-volatile memory device 220 are in a busy state, and whether a plurality of NAND dies are in a busy state in order to issue metadata. Specific details are explained in FIG. 8 and below according to some example embodiments.

The memory 216 can operate as a buffer memory, cache memory, and/or operating memory of the processor 214. According to some example embodiments, the memory 216 may include a DRAM, a SRAM, or the like, but example embodiments are not necessarily limited thereto.

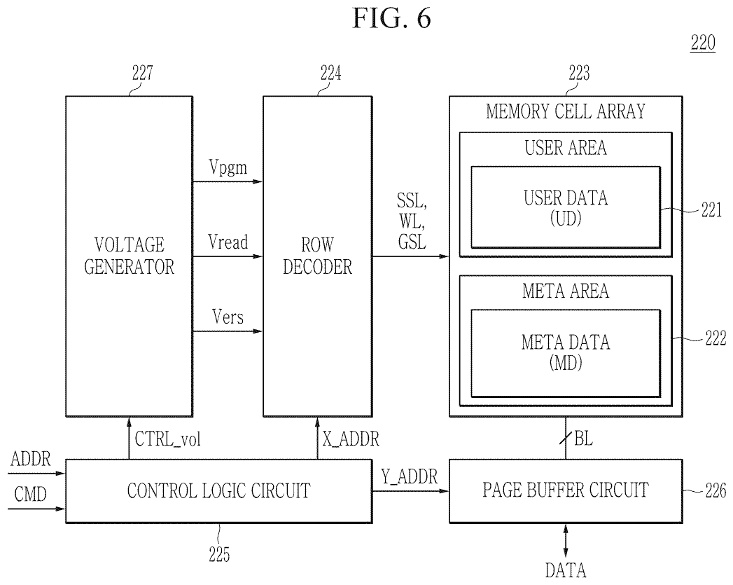

FIG. 6 is a block diagram illustrating a non-volatile memory device according to some example embodiments.

Referring to FIG. 6, a non-volatile memory device 220 may include a memory cell array 223, a row decoder 224, a control logic circuit 225, a page buffer circuit 226, and a voltage generator 227. Meanwhile, although not shown in FIG. 6, in some example embodiments, the non-volatile memory device 220 may further include a memory interface circuit e.g., 212b of FIG. 4 and may further include column logic, a pre-decoder, a temperature sensor, a command decoder, an address decoder, etc.

The memory cell array 223 can be connected to a page buffer circuit 226 through a bit line BL, and can be connected to a row decoder 224 through a plurality of word lines WL, a plurality of string select lines SSL, and a plurality of ground select lines GSL.

The memory cell array 223 may include a user area 221 and a meta area 222. The user area 221 may correspond to an area storing user data UD, and the meta area 222 may correspond to an area storing metadata MD.

Each of the user area 221 and the meta area 222 may include a plurality of memory blocks. Each of the plurality of memory blocks may include a plurality of pages, and each of the plurality of pages may include a plurality of memory cells.

In some example embodiments, the memory blocks included in the user area 221 may be multi-level cell blocks including multi-level cell (MLC) that store at least 2-bit data, triple-level cell blocks including triple-level cell (TLC), or quad-level cell blocks including quad-level cell (QLC). In some example embodiments, the memory blocks included in the meta area 222 may be single-level cell blocks including single-level cell (SLC) that store 1-bit data.

The control logic circuit 225 can control various operations within the non-volatile memory device 220. The control logic circuit 225 can output various control signals in response to a command CMD and/or address ADDR received from a storage controller e.g., 210 of FIG. 4. The control logic circuit 225 can output a control signal for writing or programming data DATA into the memory cell array 223, reading data DATA from the memory cell array 223, and/or erasing data stored in the memory cell array 223. For example, the control logic circuit 225 can output a voltage control signal CTRL_vol, a row address X_ADDR, and a column address Y_ADDR.

Various control signals output from the control logic circuit 225 can be provided to a voltage generator 227, a row decoder 224, and a page buffer circuit 226. The control logic circuit 225 can provide a voltage control signal CTRL_vol to the voltage generator 227.

The voltage generator 227 can be connected to the memory cell array 223 through a plurality of word lines WL. The voltage generator 227 can generate various types of voltages for performing program, read, and erase operations on the memory cell array 223 based on a voltage control signal CTRL_vol. The voltage generator 227 can generate, for example, a program voltage Vpgm, a pass voltage Vpass, and an erase voltage Vers. In some example embodiments, the pass voltage Vpass may be a voltage applied to an unselected word line during a read or verify operation.

The row decoder 224 can select a specific, or alternatively desired word line among the word lines WL in response to a row address X_ADDR received from the control logic circuit 225. For example, during program operation, the row decoder 224 can provide a program voltage Vpgm to a selected word line. In some example embodiments, the row decoder 224 can select some of the string selection lines SSL or some of the ground selection lines GSL in response to the row address X_ADDR received from the control logic circuit 225.

The page buffer circuit 226 can be connected to the memory cell array 223 through a plurality of bit lines BL. The page buffer circuit 226 can select some bit lines among a plurality of bit lines BL in response to a column address Y_ADDR received from the control logic circuit 225. During a program operation or read operation, the page buffer circuit 226 can operate as a sense amplifier to sense data DATA stored in the memory cell array 223.

In some example embodiments, when the program is operating, the page buffer circuit 226 can operate as a write driver to input data DATA to be stored in the memory cell array 223. The page buffer circuit 226 can store data DATA read from the memory cell array 223 and/or data DATA to be written to the memory cell array 223.

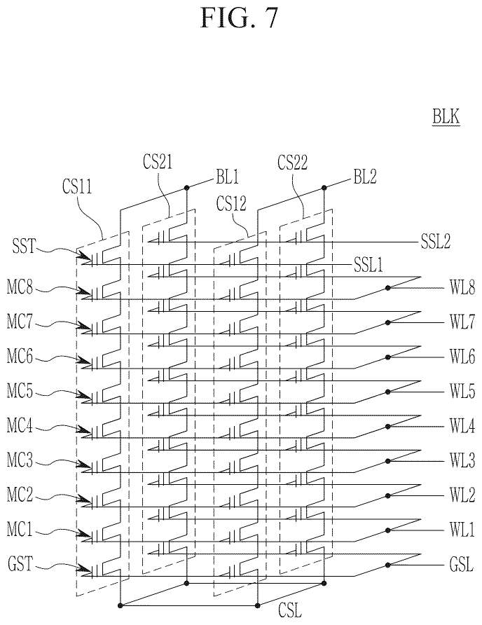

FIG. 7 is a circuit diagram exemplarily showing one memory block among a plurality of memory blocks included in a memory cell array according to some example embodiments.

Referring to FIG. 7, a memory block BLK may include a plurality of cell strings CS11-CS12, CS21-CS22. The plurality of cell strings CS11-CS12, CS21-CS22 can be connected between bit lines BL1, BL2 and a common source line CSL. Each of the plurality of cell strings CS11-CS12, CS21-CS22 may include a string select transistor SST, the plurality of memory cells MC1-MC8, and a ground select transistor GST.

The string select transistors SST can be connected to the string select lines SSL1-SSL2, respectively. Each of the plurality of memory cells MC1-MC8 can be connected to the plurality of wordlines WL1-WL8. A ground select transistor GST can be connected to a ground select line GSL. A string select transistor SST can be connected to bit lines BL1, BL2, and a ground select transistor GST can be connected to a common source line CSL. Wordlines of the same height e.g., WL1 can be connected in common. For example, when programming memory cells connected to the first word line WL1 and included in the cell string CS11, CS12, the first word line WL1 and the first string select line SSL1 can be selected.

In some example embodiments, the program operation or read operation may be performed on a row-by-row basis of cell strings CS11-CS22. Cell strings CS11-CS22 can be selected in one row by string selection lines SSL1-SSL2.

In a selected row of cell strings CS11-CS22, program operations or read operations can be performed on a page-by-page basis. A page can be a single row of memory cells connected to a single wordline. In a selected row of cell strings CS11-CS22, memory cells can be selected in units of pages by word lines WL1-WL8.

In some example embodiments, a plurality of cell strings CS11-CS12, CS21-CS22 may be formed in a direction perpendicular to a substrate (not shown), and a string select transistor SST, a plurality of memory cells MC1-MC8, and a ground select transistor GST may be stacked in a direction perpendicular to the substrate (not shown).

For example, the memory block BLK may be a memory block with a three-dimensional structure. Memory cells included in a memory block having a three-dimensional structure may be charge capture flash memory cells. Charge capture flash memory cells can store data by trapping charges in a charge storage film.

The memory block BLK illustrated in FIG. 7 is exemplary and example embodiments are not necessarily limited thereto. For example, compared to the memory block BLK illustrated in FIG. 7, the number of rows of cell strings may be increased or decreased, and as the number of rows of cell strings is changed, the number of string select lines or ground select lines connected to the rows of cell strings, and the number of cell strings connected to one bit line may also be changed.

Also, compared to the memory block BLK illustrated in FIG. 7, in some example embodiments the number of columns of cell strings may be increased or decreased, and as the number of columns of cell strings is changed, the number of bit lines connected to the columns of cell strings and the number of cell strings connected to one string selection line may also be changed.

In some example embodiments, compared to the memory block BLK illustrated in FIG. 7, the height of the cell strings may be increased or decreased, and the number of memory cells stacked in each of the cell strings may be increased or decreased. As the number of memory cells stacked in each cell string changes, the number of word lines can also change.

In some example embodiments, the number of string select transistors or ground select transistors provided for each of the cell strings can be increased. As the number of string select transistors or ground select transistors provided for each of the cell strings changes, the number of string select lines or ground select lines can also change. As the number of string select transistors or ground select transistors increases, the string select transistors or ground select transistors can be stacked in the same form as the memory cells MC1-MC8.

FIG. 8 is a diagram for explaining the operation of a storage device according to some example embodiments.

Referring to FIG. 8, the NAND controller 215 may include a plurality of cores CORE1 to CORE8. The NAND controller 215 may correspond to the NAND controller 215 illustrated in FIG. 5. Multiple paths PATH1 to PATH8 corresponding to the plurality of cores CORE1 to CORE8 can be connected to the plurality of cores CORE1 to CORE8, and user data UD and metadata MD can be transmitted or sent to any one of the plurality of cores CORE1 to CORE8 corresponding to each path PATH1 to PATH8.

For example, user data UD and metadata MD can be transmitted or sent to the corresponding third core CORE3 via the third path PATH3. User data UD and metadata MD can be processed according to the task order of a request e.g., a request REQ from the host 100 referring to FIG. 1 pending in the task queue of the third core CORE3.

Each of the plurality of cores CORE1 to CORE8 can be connected to the plurality of channels. In some example embodiments, each of the plurality of channels can be connected to the plurality of NAND dies. For example, the third core CORE3 may be connected to the first channel CH1 and the second channel CH2, the first channel CH1 may be connected to the eleventh to eighteenth NAND dies ND11 to ND18, and the second channel CH2 may be connected to the twenty-first to twenty-eighth NAND dies N21 to N28. For convenience of explanation, the paths, channels, and the plurality of NAND dies for the third core CORE3 are described, but, according to some example embodiments, substantially the same configuration can be applied to the other remaining cores.

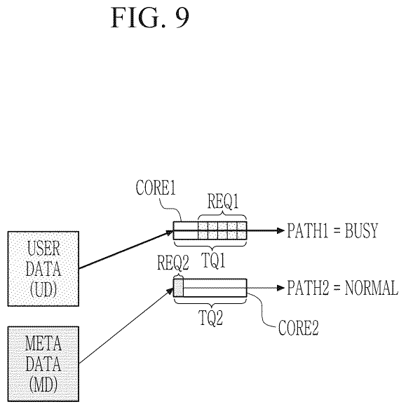

Each of the plurality of cores CORE1 to CORE8 can execute software to monitor whether the plurality of paths PATH1 to PATH8 are busy, whether the plurality of channels CH1 to CH2 connected to each of the plurality of cores CORE1 to CORE8 are busy, and/or whether the plurality of NAND dies ND11 to ND28 connected to the plurality of channels CH1 to CH2 are busy. Accordingly, in some example embodiments, improved performance of the storage device can be provided by checking the traffic status along the transmission path of user data UD and determining the storage and/or issue location of metadata. Specific details, according to some example embodiments, are explained in FIG. 9 and below.

FIG. 9 is a diagram for explaining the operation of a storage device according to some example embodiments.

Referring to FIG. 9, user data MD and metadata MD can be transmitted or sent to either the first core CORE1 or the second core CORE2 corresponding to each other via either the first path PATH1 or the second path PATH2. For example, as illustrated in FIG. 9, user data UD can be transmitted or sent to the first core CORE1 via the first path PATH1.

Whether the first path PATH1 is busy can be determined based on the number of pending requests REQ1 in the task queue TQ1 of the first core CORE1 corresponding to the first path PATH1. For example, as illustrated in FIG. 9, a first core CORE1 corresponding to a first path PATH1 may have five pending requests for user data UD, and if the number of pending requests is greater than a predetermined, or alternatively desired threshold or if there are more pending requests than the number of pending requests in other cores, the first core CORE1 may be determined to be busy.

In some example embodiments, the second path PATH2 corresponding to the second core CORE2 can be determined to be in a normal state. Based on the determination that the first path PATH1 is in a busy state and the second path PATH2 is in a normal state, the metadata MD can be transmitted or sent to the second core CORE2 through the second path PATH2.

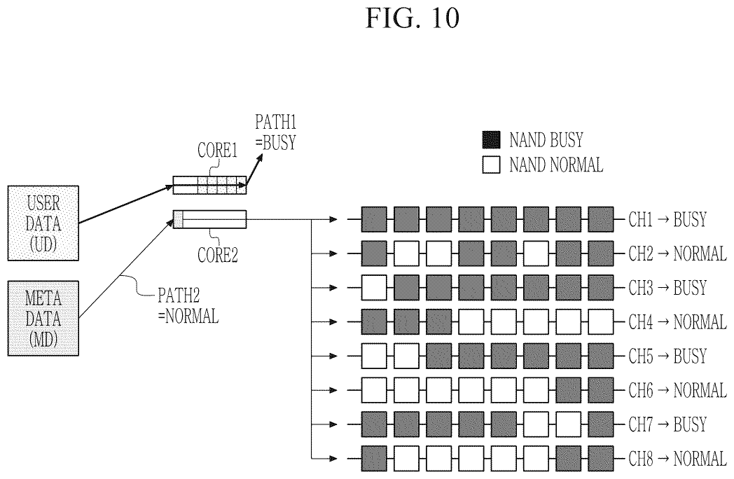

FIG. 10 is a diagram for explaining the operation of a storage device according to some example embodiments.

Referring to FIG. 10, a plurality of channels CH1 to CH8 may be connected to the second core CORE2, and a plurality of NAND dies may be connected to each of the plurality of channels CH1 to CH8. The second core CORE2 can monitor the busy status of each of the plurality of channels CH1 to CH8.

For example, the second core CORE2 can monitor the number of NAND dies in a busy state among the plurality of NAND dies connected to each of the plurality of channels CH1 to CH8. When the number of NAND dies in a busy state among plurality of NAND dies connected to a specific channel exceeds a predetermined, or alternatively desired threshold and/or a relatively larger number of NAND dies are in a busy state compared to other channels, the second core CORE2 can determine that the channel is in a busy state.

For example, when the predetermined, or alternatively desired threshold value is 6, the second core CORE2 can determine that the first channel CH1 with eight NAND dies busy, the third channel CH3 with seven NAND dies busy, the fifth channel CH5 and the seventh channel CH7 with six NAND dies busy are busy. In some example embodiments, when the predetermined, or alternatively desired threshold value is 6, the second core CORE2 can determine that the second channel CH2 with five NAND dies busy, the fourth channel CH4 and the eighth channel CH8 with three NAND dies busy, and the sixth channel CH6 with two NAND dies busy are normal.

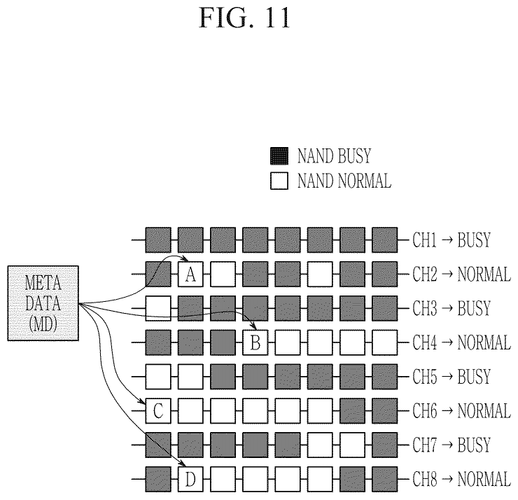

FIG. 11 is a diagram for explaining the operation of a storage device according to some example embodiments.

Referring to FIG. 11, as described with respect to FIG. 10, the second core CORE2 can monitor whether each of the plurality of NAND dies connected to each of the second channel CH2, the fourth channel CH4, the sixth channel CH6, and the eighth channel CH8, which are determined to be in a normal state, is in a busy state. The second core CORE2 can issue metadata MD to a NAND die that is in a normal state among the plurality of monitored NAND dies.

For example, as illustrated in FIG. 11, metadata may be preferentially issued to any one of the “A” NAND die connected to the second channel CH2, the “B” NAND die connected to the fourth channel CH4, the “C” NAND die connected to the sixth channel CH6, and the “D” NAND die connected to the eighth channel CH8. For example, if the weighting is high for the degree of busy state of a channel, metadata MD can be preferentially issued to the “C” NAND die of the sixth channel CH6 which has the fewest number of NAND dies in a busy state.

In some example embodiments, when the number of NAND dies in a busy state, such as the fourth channel CH4 and the eighth channel CH8, is the same, the second core CORE2 can monitor the number of metadata issues for each of the plurality of NAND dies connected to each of the fourth channel CH4 and the eighth channel CH8. For example, the second core CORE2 can monitor the number of metadata issues of the “B” NAND die and the “D” NAND die, and if the number of metadata issues of the “B” NAND die is greater than the number of metadata issues of the “D” NAND die, metadata MD can be issued to the “D” NAND die. However, example embodiments are not necessarily limited thereto, and in some example embodiments the issue priorities of metadata MD can be implemented in various different ways.

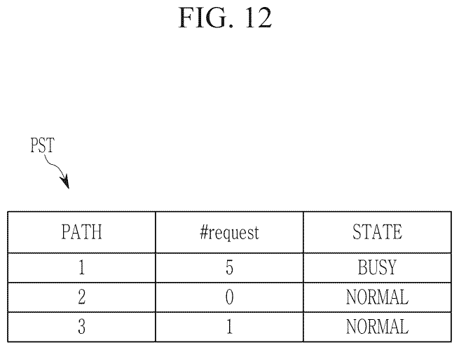

FIGS. 12 to 15 are drawings for explaining the operation of a storage device according to some example embodiments.

Referring to FIG. 12, the NAND controller 215 of FIG. 5 can determine whether each of the plurality of paths is in a busy state as described with respect to FIGS. 8 to 11, and whether each of the plurality of paths is in a busy state can be stored in a path state table PST. The path state table PST may be temporarily stored in memory 216 in FIG. 5 during operation of the storage device, for example, but the example embodiments are not limited thereto.

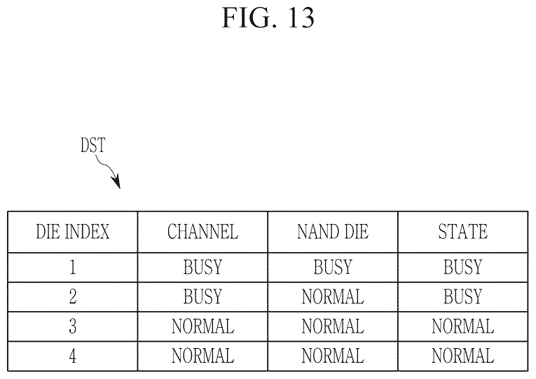

Referring to FIG. 13, the NAND controller can determine whether each of the plurality of channels and each of the plurality of NAND dies is in a busy state as described with respect to FIGS. 8 to 11, and whether each of the plurality of channels and each of the plurality of NAND dies is in a busy state can be stored in a die state table DST. The die state table DST may be temporarily stored in memory during operation of the storage device, for example, but example embodiments are not limited thereto.

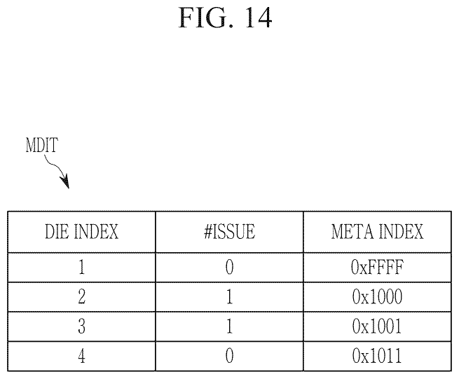

Referring to FIG. 14, the NAND controller can monitor the number of metadata issues of each of the plurality of NAND dies as described with respect to FIGS. 8 to 11. The NAND controller can monitor the number of metadata issues for each of plurality of NAND dies by referencing the metadata issue table MDIT. When a NAND controller issues specific metadata to a specific NAND die, it can update the metadata issue table MDIT by updating the issue count and meta index corresponding to the NAND die.

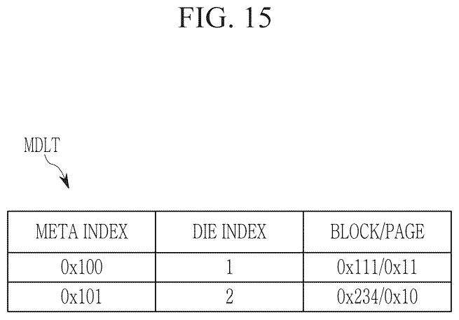

Referring to FIG. 15, the NAND controller may issue metadata to any one of the plurality of NAND dies as described with respect to FIGS. 8 through 11. The issue location of the metadata can be stored in a non-volatile memory device 220 in FIG. 1 as a metadata location table MDLT. The NAND controller can update the storage location e.g., block and page for a given meta index when specific metadata is issued to a specific NAND die.

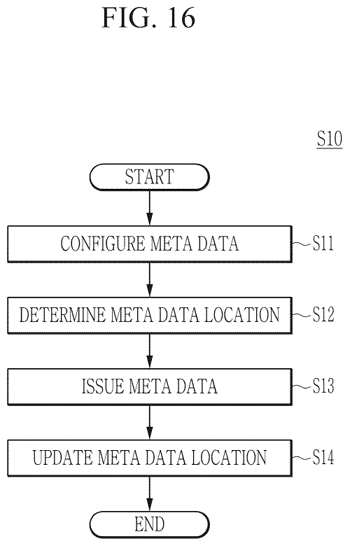

FIG. 16 is a flowchart illustrating the operation of a storage device according to some example embodiments.

Referring to FIG. 16, the operating method S10 of the storage device may include a step S11 of configuring metadata. For example, a storage device 200 in FIG. 1 can configure metadata based on data DATA_h in FIG. 1 provided from a host 100 in FIG. 1.

The method of operating the storage device S10 may include a step S12 of determining a location where metadata is to be stored. For example, a NAND controller 215 in FIG. 5 can determine a NAND die on which metadata is to be stored based on whether plurality of paths are busy, whether plurality of channels are busy, and/or whether plurality of NAND dies are busy. In some example embodiments, the NAND controller can determine the NAND die on which the metadata will be stored based further on the number of metadata issue counts for each of the plurality of NAND dies.

The method of operating the storage device S10 may include a step of issuing metadata S13. For example, the NAND controller can issue metadata to the NAND die determined in step S12.

The method of operating the storage device S10 may include a step of updating the location of metadata S14. For example, the NAND controller can update a metadata location table MDLT of FIG. 15 regarding stored metadata and the location where the metadata is stored, and cause the metadata location table MDLT to be stored in a non-volatile memory device 220 of FIG. 1.

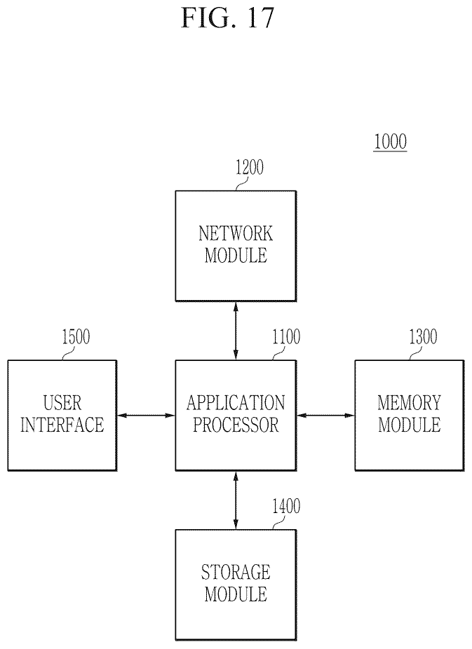

FIG. 17 is a block diagram exemplarily showing a mobile system to which a storage device according to some example embodiments is applied.

Referring to FIG. 17, the mobile system 1000 may include an application processor 1100, a network module 1200, a memory module 1300, a storage module 1400, and a user interface 1500. The application processor 1100 may have a configuration corresponding to the host 100 of FIG. 1, and a detailed description thereof may be replaced with the description of FIG. 1.

The network module 1200 can communicate with external devices. For example, the network module 1200 can support wireless communications such as Code Division Multiple Access, Global System for Mobile communication, wideband CDMA, CDMA-2000, Time Division Multiple Access, Long Term Evolution, Wimax, WLAN, UWB, Bluetooth, WI-DI, etc., but example embodiments are not limited thereto.

The memory module 1300 can operate as a main memory, operating memory, buffer memory, and/or cache memory of the mobile system 1000. The memory module 1300 may include volatile random access memory such as DRAM, SDRAM, DDR SDRAM, DDR2 SDRAM, DDR3 SDRAM, LPDDR SDARM, LPDDR3, SDRAM, LPDDR3 SDRAM, etc., or non-volatile random access memory such as PRAM, ReRAM, MRAM, FRAM, etc., but example embodiments are not limited thereto.

The storage module 1400 can store data. For example, the storage module 1400 can store data received from outside (e.g., data received from outside the mobile system 1000). The storage module 1400 can transmit or send data stored in the storage module 1400 to the application processor 1100. For example, the storage module 1400 may be implemented with a non-volatile semiconductor memory device such as PRAM, MRAM, RRAM, NAND flash, NOR flash, and/or a three-dimensional structured NAND flash. For example, the storage module 1400 may be provided as a solid state drive SSD, a multimedia card MMC, an embedded multimedia card eMMC, a universal flash storage UFS, etc., but example embodiments are not limited thereto.

The storage module 1400 can store metadata based on whether the path, channel, and each NAND die corresponding to each core is in a busy state according to processing of user data, as described in FIGS. 1 to 16 according to some example embodiments.

In some example embodiments, the storage module 1400 can uniformly store metadata in plurality of NANDs by considering the traffic of user data UD through the above-described metadata storage method according to some example embodiments, thereby improving the performance of the storage module 1400.

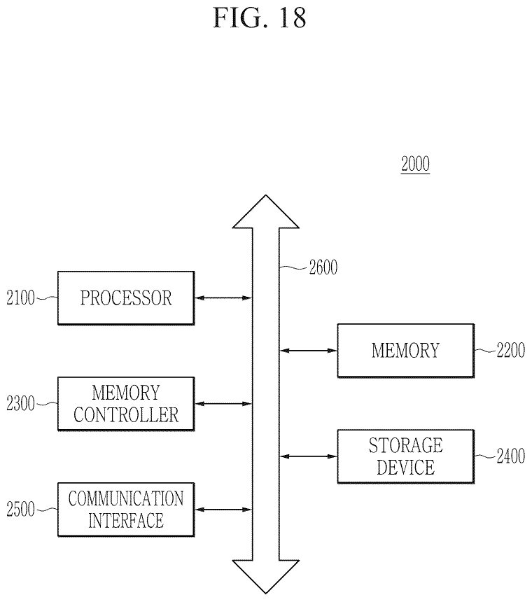

FIG. 18 is a block diagram exemplarily showing a computing device to which a storage device according to some example embodiments is applied.

Referring to FIG. 18, a computing device 2000 may include a processor 2100, a memory 2200, a memory controller 2300, a storage device 2400, a communication interface 2500, and a bus 2600. In some example embodiments, the computing device 2000 may further include other general-purpose components (not shown).

The processor 2100 can control the overall operation of each component of the computing device 2000. The processor 2100 may be implemented as at least one of various processing units such as a CPU, an AP, and/or a GPU, but example embodiments are not limited thereto.

Memory 2200 can store various data and/or commands. The memory controller 2300 can control the transfer of data and/or commands to and from the memory 2200. In some example embodiments, the memory controller 2300 may be provided as a separate chip from the processor 2100. In some example embodiments, the memory controller 2300 may be provided as an internal component of the processor 2100.

The storage device 2400 non-temporarily stores programs and/or data. In some example embodiments, the storage device 2400 may be implemented as non-volatile memory. In some example embodiments, the storage device 2400 may be implemented as a storage device as described with reference to FIGS. 1 to 16.

The communication interface 2500 can support wired and wireless Internet communication of the computing device 2000. According to some example embodiments, the communication interface 2500 may support various communication methods other than Internet communication.

The bus 2600 can provide communication capabilities between components of the computing device 2000. The bus 2600 may include at least one type of bus depending on the communication protocol between the components.

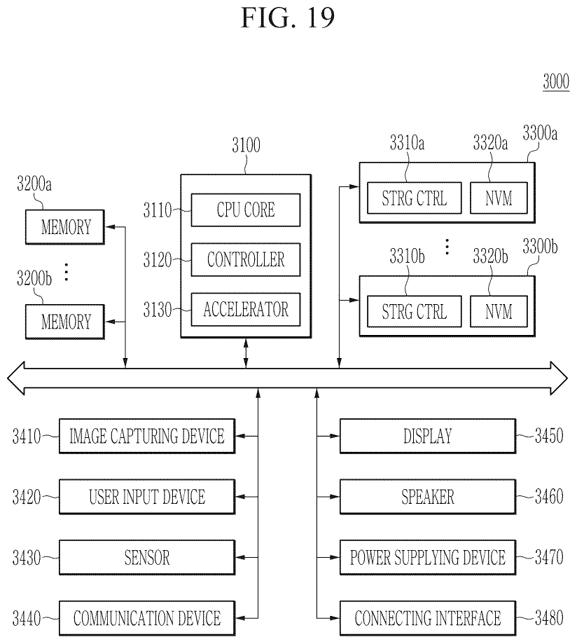

FIG. 19 is a block diagram exemplarily showing a system to which a storage device according to some example embodiments is applied.

Referring to FIG. 19, the system 3000 may be a mobile system, such as a mobile phone, a smart phone, a tablet personal computer, a wearable device, a healthcare device, and/or an Internet of Things IoT device. However, example embodiments are not necessarily limited thereto, and in some example embodiments the system 3000 of FIG. 19 may be a personal computer, a laptop computer, a server, a media player, and/or an automotive device such as a navigation device.

The system 3000 may include a main processor 3100, a memory 3200a, 3200b, and a storage device 3300a, 3300b, and may additionally include one or more of an image capturing device 3410, a user input device 3420, a sensor 3430, a communication device 3440, a display 3450, a speaker 3460, a power supplying device 3470, and a connecting interface 3480.

The main processor 3100 can control the overall operation of the system 3000, more specifically, the operation of other components that make up the system 3000. Such a main processor 3100 may be implemented as a general-purpose processor, a dedicated processor, or an application processor.

The main processor 3100 may include one or more CPU cores 3110 and may further include a controller 3120 for controlling memory 3200a, 3200b and/or storage devices 3300a, 3300b. In some example embodiments, the main processor 3100 may further include an accelerator 3130, which is a dedicated circuit for high-speed data operations such as AI Artificial Intelligence data operations. Such an accelerator 3130 may include a GPU, an NPU, and/or a DPU, and may be implemented as a separate chip that is physically independent from other components of the main processor 3100.

Memory 3200a, 3200b may be used as a main memory device of the system 3000 and may include volatile memory such as SRAM and/or DRAM, but may also include non-volatile memory such as flash memory, PRAM and/or RRAM. The memory 3200a, 3200b may also be implemented within the same package as the main processor 3100.

The storage device 3300a, 3300b can function as a non-volatile storage device that stores data regardless of whether power is supplied, and can have a relatively large storage capacity compared to the memory 3200a, 3200b. A storage device 3300a, 3300b may include a storage controller 3310a, 3310b and a non-volatile memory 3320a, 3320b that stores data under the control of the storage controller 3310a, 3310b. The non-volatile memory 3320a, 3320b may include flash memory of a 2D 2-dimensional structure or a 3D 3-dimensional V-NAND Vertical NAND structure, but may also include other types of non-volatile memory such as PRAM and/or RRAM.

The storage device 3300a, 3300b may be included in the system 3000 physically separated from the main processor 3100, or may be implemented within the same package as the main processor 3100. In some example embodiments, the storage device 3300a, 3300b may have a form such as a solid state device SSD or a memory card, and may be detachably connected to other components of the system 3000 through an interface such as a connection interface 3480 to be described later. Such storage devices 3300a, 3300b may be devices to which standard specifications such as UFS Universal Flash Storage, eMMC embedded multi-media card and/or NVMe non-volatile memory express are applied, but example embodiments are not necessarily limited thereto. The storage device 3300a, 3300b may include a storage device as described in FIGS. 1 to 16.

The image capturing device 3410 can capture still and/or moving images and may be a camera, a camcorder, and/or a webcam.

The user input device 3420 can receive various types of data input from a user of the system 3000, and may be a touch pad, a keypad, a keyboard, a mouse, and/or a microphone.

The sensor 3430 can detect various types of physical quantities that can be obtained from outside the system 3000 and convert the detected physical quantities into electrical signals. Such sensors 1430 may be temperature sensors, pressure sensors, light sensors, position sensors, acceleration sensors, biosensors, and/or gyroscope sensors.

The communication device 3440 can transmit or send and/or receive signals between other devices outside the system 3000 according to various communication protocols. Such a communication device 3440 may be implemented including an antenna, a transceiver, and/or a modem.

The display 3450 and speaker 3460 can function as output devices that output visual information and auditory information, respectively, to the user of the system 3000.

The power supplying unit 3470 can appropriately convert power supplied from a battery (not shown) built into the system 3000 and/or an external power source and supply it to each component of the system 3000.

A connecting interface 3480 can provide a connection between the system 3000 and an external device that is connected to the system 3000 and can exchange data with the system 3000. The connecting interface 3480 can be implemented in various interface methods such as Advanced Technology Attachment, Serial ATA, e-SATA external SATA, Small Computer Small Interface, Peripheral Component Interconnection, PCIe PCI express, NVMe, IEEE 1394, USB universal serial bus, SD secure digital card, MMC multi-media card, eMMC, UFS, embedded Universal Flash Storage, CF compact flash card interface, etc., but example embodiments are not limited thereto.

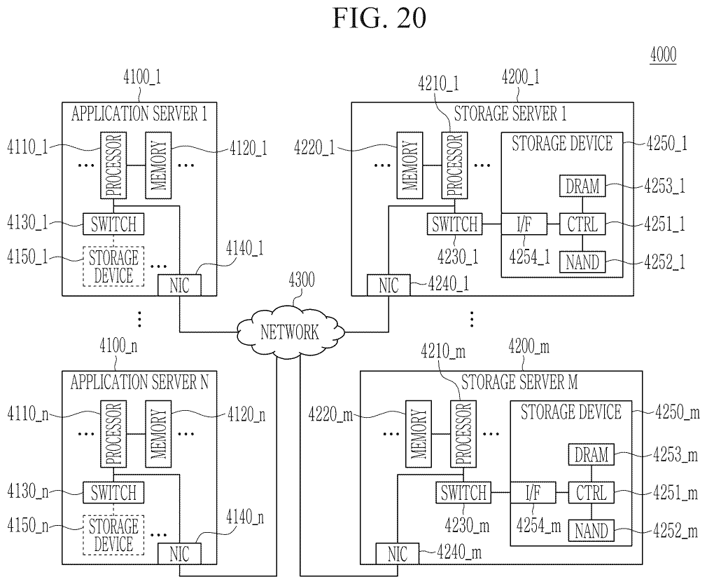

FIG. 20 is a block diagram exemplarily showing a system to which a storage device according to some example embodiments is applied.

Referring to FIG. 20, a data center 4000 is a facility that collects various types of data and provides services, and may also be referred to as a data storage center. The data center 4000 may be a system for operating a search engine and database, and may be a computing system used in a company such as a bank or a government agency.

The data center 4000 may include application servers 4100_1 to 4100_n and storage servers 4200_1 to 4200_m. The number of application servers 4100_1 to 4100_n and the number of storage servers 4200_1 to 4200_m may be variously selected depending on some example embodiments, and the number of application servers 4100_1 to 4100_n and the number of storage servers 4200_1 to 4200_m may be different from each other.

The application servers 4100_1 to 4100_n and/or the storage servers 4200_1 to 4200_m may include at least one of a processor 4110_1 to 4110_n, 4210_1 to 4210_m and a memory 4120_1 to 4120_n, 4220_1 to 4220_m. Taking the storage server 4200_1 as an example, the processor 4210_1 can control the overall operation of the storage server 4200_1 and access the memory 4220_1 to execute commands and/or data loaded into the memory 4220_1. The memory 4220_1 may be DDR SDRAM, HBM, Hybrid Memory Cube, Dual In-line Memory Module, Optane DIMM, and/or NVMDIMM Non-Volatile DIMM, but example embodiments are not limited thereto. According to some example embodiments, the number of processors 4210_1 and the number of memories 4220_1 included in the storage server 4200_1 may be selected in various different ways.

In some example embodiments, the processor 4210_1 and memory 4220_1 may provide a processor-memory pair. In some example embodiments, the number of processors 4210_1 and memories 4220_1 may be different from each other. The processor 4210_1 may include a single core processor or a multi-core processor. The above description of the storage server 4200_1 according to some example embodiments can be similarly applied to the application server 4100_1. According to some example embodiments, the application server 4100_1 may not include a storage device 4150_1. The storage server 4200_1 may include at least one storage device 4250_1. The number of storage devices 4250_1 included in the storage server 4200_1 may be selected in various ways according to some example embodiments. The storage device 4250_1 may include a storage device as described in FIGS. 1 to 16.

One or more of the elements disclosed above may include or be implemented in one or more processing circuitries such as hardware including logic circuits; a hardware/software combination such as a processor executing software; or a combination thereof. For example, the processing circuity more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a solid state drive (SSD), storing a program of instructions, and a processor (e.g., CPU) configured to execute the program of instructions to implement the functionality and/or methods performed by some or all of any devices, electronic devices, modules, units, and/or portions thereof according to any of the example embodiments.

Any of the memories described herein may be a nonvolatile memory, such as a flash memory, a phase-change random access memory (PRAM), a magneto-resistive RAM (MRAM), a resistive RAM (ReRAM), or a ferro-electric RAM (FRAM), or a volatile memory, such as a static RAM (SRAM), a dynamic RAM (DRAM), or a synchronous DRAM (SDRAM).

Any or all of the elements described with reference to the figures may communicate with any or all other elements described with reference to figures. For example, any element may engage in one-way and/or two-way and/or broadcast communication with any or all other elements in the figures, to transfer and/or exchange and/or receive information such as but not limited to data and/or commands, in a manner such as in a serial and/or parallel manner, via a bus such as a wireless and/or a wired bus (not illustrated). The information may be in encoded various formats, such as in an analog format and/or in a digital format.

Although some example embodiments of the present inventive concepts have been described in detail above, the scope of the present inventive concepts are not limited thereto, and various modifications and improvements made by those skilled in the art using some example embodiments of the present inventive concepts defined in the following claims also fall within the scope of the present inventive concepts.

What is claimed is:

1. A storage device, comprising:
a non-volatile memory device including a plurality of memory cells configured to store user data and metadata; and
a storage controller including a plurality of cores, the storage controller configured to issue the metadata to one of the plurality of memory cells based on whether each of a plurality of paths corresponding to each of the plurality of cores is in a busy state.

2. The storage device of claim 1, wherein:
the busy state of each of the plurality of paths is determined based on a number of pending requests in a task queue of a core corresponding to each of the plurality of paths.

3. The storage device of claim 1, wherein:
in response to a first path among the plurality of paths being in the busy state and a second path among the plurality of paths being in a normal state, the storage controller is configured to monitor whether each of a plurality of channels connected to a core corresponding to the second path is in the busy state.

4. The storage device of claim 3, wherein:
the busy state of each of the plurality of channels is determined based on a number of memory cells that are in the busy state among the plurality of memory cells connected to each of the plurality of channels.

5. The storage device of claim 3, wherein:
in response to a first channel among the plurality of channels connected to the core being in the busy state and a second channel among the plurality of channels being in the normal state, the storage controller is configured to monitor whether each of a plurality of first memory cells connected to the second channel among the plurality of memory cells is in the busy state.

6. The storage device of claim 5, wherein:
in response to a first memory cell among the plurality of first memory cells being in the busy state and a second memory cell among the plurality of first memory cells being in the normal state, the storage controller is configured to issue the metadata to the second memory cell.

7. The storage device of claim 6, wherein:
in response to the metadata being issued to the second memory cell, the storage controller is configured to update a metadata location table.

8. The storage device of claim 5, wherein:
the storage controller is configured to issue the metadata based on a number of metadata issues of each of the plurality of first memory cells connected to the second channel among the plurality of memory cells.

9. The storage device of claim 8, wherein:
in response to the number of metadata issues of a first memory cell among the plurality of first memory cells being greater than the number of metadata issues of a second memory cell among the plurality of first memory cells, the storage controller is configured to issue the metadata to the second memory cell and update a metadata issue table.

10. The storage device of claim 1, wherein:
the plurality of memory cells include a plurality of first memory blocks configured to store the user data, and a plurality of second memory blocks configured to store the metadata and different from the plurality of first memory blocks.

11. The storage device of claim 10, wherein:
the plurality of second memory blocks are single-level cell SLC blocks.

12. A storage device, comprising:
a non-volatile memory device including a plurality of memory cells configured to store user data and metadata; and
a storage controller configured to issue the metadata to a plurality of first memory cells among the plurality of memory cells based on whether each of the plurality of memory cells is in a busy state.

13. The storage device of claim 12, wherein:
the plurality of first memory cells are connected to a first channel in a normal state among a plurality of channels connected to the non-volatile memory device.

14. The storage device of claim 12, wherein:
the plurality of first memory cells include a first memory cell and a second memory cell in a normal state, and
the storage controller is configured to issue the metadata to one of the first memory cell and the second memory cell based on a number of metadata issues of the first memory cell and the second memory cell.

15. The storage device of claim 14, wherein:
in response to the number of metadata issues of the first memory cell being greater than the number of metadata issues of the second memory cell, the storage controller is configured to issue the metadata to the second memory cell and update a metadata issue table and a metadata location table.

16. The storage device of claim 13, wherein:
a number of memory cells in the busy state among the plurality of memory cells connected to the first channel is less than or equal to a threshold value.

17. The storage device of claim 13, wherein:
the storage controller comprises a plurality of cores, and the first channel is connected to a first core corresponding to a first path in the normal state among the plurality of cores.

18. The storage device of claim 17, wherein:
a number of pending requests in a task queue of the first core is less than a threshold.

19. A method of operating a storage device, comprising:
constructing metadata based on user data;
determining a location where the metadata is to be stored based on whether each of a plurality of paths corresponding to each of a plurality of cores included in a storage controller is in a busy state, whether each of a plurality of channels connected to each of the plurality of cores is in the busy state, and whether each of a plurality of memory cells of a non-volatile memory device is in the busy state;
issuing the metadata to the location; and
updating the location of the metadata.

20. The method of operating the storage device of claim 19, further comprising:
determining the location where the metadata is to be stored based on a number of metadata issues of each of the plurality of memory cells.
